(19) United States
(12) Patent Application Publication
(10) Pub. No.: US 2025/0192496 A1
(43) Pub. Date: Jun. 12, 2025

(54) RELAY CONNECTOR

(71) Applicant: SUMITOMO WIRING SYSTEMS, LTD., Mie (JP)

(72) Inventor: Tomoyuki KONDO, Mie (JP)

(21) Appl. No.: 18/840,507

(22) PCT Filed: Feb. 7, 2023
(86) PCT No.: PCT/JP2023/003957

§ 371 Date: Aug. 22, 2024

(30) Foreign Application Priority Data
Feb. 28, 2022 (JP) 2022-029944

(51) Int. Cl. H01R 31/06

(52) U.S. Cl. CPC H01R 31/06

(57) ABSTRACT

A relay connector includes a connector housing including a first connector housing portion, a second connector housing portion and a partitioning portion, a plurality of terminals, and a holder for holding the plurality of terminals. The partitioning portion includes a plurality of insertion holes and a holder recess. Each of the plurality of terminals includes an inserting portion, a first terminal portion, a holder held portion, and a second terminal portion. At least one terminal includes a press-fit portion to be press-fit into the insertion hole. At least one terminal includes a bent portion bent with respect to the inserting portion. The holder includes a grooved holder member having a plurality of holding grooves and a lid holder member.

### TECHNICAL FIELD

The present disclosure relates to a relay connector.

### BACKGROUND

Patent Document 1 discloses a relay connector provided with a connector housing, a plurality of terminals, a seal member and an alignment holder. The connector housing includes a partition wall, and the partition wall is formed with insertion holes. The terminals are press-fit into the insertion holes of the partition wall, thereby being held in a certain posture.

### PRIOR ART DOCUMENT

### Patent Document

Patent Document 1: JP 2014-093248 A

### SUMMARY OF THE INVENTION

### Problems to be Solved

For example, bent portions may be set in intermediate parts of terminals to convert array positions of the terminals such as when the arrays of the terminals are different on both sides of a relay connector. In the relay connector of a type that the terminals are press-fit, it is desired to suppress the deformation of the bent portions set in the intermediate parts of the terminals.

Accordingly, the present disclosure aims to suppress the deformation of a bent portion set in an intermediate part of a terminal in a relay connector of a type that the terminal is press-fit.

### Means to Solve the Problem

The present disclosure is directed to a relay connector with a connector housing including a first connector housing portion, a second connector housing portion and a partitioning portion between the first connector housing portion and the second connector housing portion, a plurality of terminals, and a holder for holding the plurality of terminals, the partitioning portion including a plurality of insertion holes, the plurality of terminals being respectively inserted into the plurality of insertion holes, and a holder recess for accommodating the holder on a side closer to the second connector housing portion than the plurality of insertion holes, each of the plurality of terminals including an inserting portion to be inserted into the insertion hole, a first terminal portion extending further toward the first connector housing portion than the inserting portion along an extension of the inserting portion, a holder held portion extending into the holder recess from the inserting portion, and a second terminal portion extending toward the second connector housing portion from the holder held portion, the inserting portion of at least one of the plurality of terminals including a press-fit portion to be press-fit into the insertion hole, the holder held portion of at least one of the plurality of terminals including a bent portion bent with respect to the inserting portion, the holder including a grooved holder member having a plurality of holding grooves capable of accommodating the plurality of holder held portions and a lid holder member for holding the plurality of holder held portions in a state accommodated in the plurality of holding grooves by being united with the grooved holder member, and the holder being accommodated in the holder recess and the press-fit portion of the at least one inserting portion being press-fit in the insertion hole by inserting the plurality of inserting portions into the plurality of insertion holes with the holder holding the plurality of holder held portions in the plurality of holding grooves.

### Effect of the Invention

According to the present disclosure, it is possible to suppress the deformation of a bent portion set in an intermediate part of a terminal in a relay connector of a type that the terminal is press-fit.

### BRIEF DESCRIPTION OF THE DRAWINGS

FIG. 1 is a perspective view showing a relay connector according to an embodiment.

FIG. 2 is a section along II-II of FIG. 1.

FIG. 3 is a perspective view showing a state before terminals and a holder are assembled with a connector housing.

FIG. 4 is a view of a partitioning portion when viewed from an opening side of a second connector housing portion.

FIG. 5 is an exploded perspective view of the terminals and the holder.

FIG. 6 is a section along VI-VI of FIG. 3.

### DETAILED DESCRIPTION TO EXECUTE THE INVENTION

### Description of Embodiments of Present Disclosure

First, embodiments of the present disclosure are listed and described.

The relay connector of the present disclosure is as follows.

(1) The relay connector of the present disclosure is provided with a connector housing including a first connector housing portion, a second connector housing portion and a partitioning portion between the first connector housing portion and the second connector housing portion, a plurality of terminals, and a holder for holding the plurality of terminals, the partitioning portion including a plurality of insertion holes, the plurality of terminals being respectively inserted into the plurality of insertion holes, and a holder recess for accommodating the holder on a side closer to the second connector housing portion than the plurality of insertion holes, each of the plurality of terminals including an inserting portion to be inserted into the insertion hole, a first terminal portion extending further toward the first connector housing portion than the inserting portion along an extension of the inserting portion, a holder held portion extending into the holder recess from the inserting portion, and a second terminal portion extending toward the second connector housing portion from the holder held portion, the inserting portion of at least one of the plurality of terminals including a press-fit portion to be press-fit into the insertion hole, the holder held portion of at least one of the plurality of terminals including a bent portion bent with respect to the inserting portion, the holder including a grooved holder member having a plurality of holding grooves capable of accommodating the plurality of holder held portions and a lid holder member for holding the plurality of holder held portions in a state accommodated in the plurality of holding grooves by being united with the grooved holder member, and the holder being accommodated in the holder recess and the press-fit portion of the at least one inserting portion being press-fit in the insertion hole by inserting the plurality of inserting portions into the plurality of insertion holes with the holder holding the plurality of holder held portions in the plurality of holding grooves.

According to this relay connector, the inserting portions can be inserted into the insertion holes and the at least one press-fit portion can be press-fit into the insertion hole with the holder holding the holder held portions in the holding grooves. Thus, the bent portion is hardly deformed during the press-fitting of the terminal. With the inserting portions inserted in the insertion holes, the bent portion is held in the holding groove of the holder in the holder recess. Thus, also after the relay connector is completed, the bent portion is hardly deformed. Therefore, the deformation of the bent portion set in an intermediate part of the terminal can be suppressed in the relay connector of a type that the terminals are press-fit.

(2) In the relay connector of (1), the bent portion of the at least one holder held portion may include a position converting bent portion bent to make a position of the first terminal portion in the second connector housing portion and a position of the second terminal portion in the second connector housing portion different.

In this way, the position of the first terminal portion in the first connector housing portion and that of the second terminal portion in the second connector housing portion can be made different by the bent portion.

(3) In the relay connector of (1) or (2), the plurality of inserting portions may be arranged in a row or a plurality of rows along a terminal array direction, and the bent portion of the at least one holder held portion may include an interval converting bent portion bent to make positions of the first terminal portion and the second terminal portion different along the terminal array direction.

In this way, the positions of the first and the second terminal portions can be made different along the terminal array direction, whereby arrangement intervals of the first terminal portions and those of the second terminal portions can be changed.

(4) In the relay connector of any of (1) to (3), the plurality of inserting portions may be arranged in a row or a plurality of rows along a terminal array direction, and the bent portion of the at least one holder held portion may include an array position converting bent portion bent to make positions of the first terminal portion and the second terminal portion different in a direction intersecting the terminal array direction.

In this way, the array position of the first terminal portion and that of the second terminal portion can be changed by making the positions of the first and second terminal portions different in the direction intersecting the terminal array direction.

(5) In the relay connector of any of (1) to (4), the partitioning portion may include a seal recess on a side closer to the first connector housing portion than the insertion holes, and the relay connector may further comprise a seal portion filled in the seal recess.

In this case, sealability is improved since the partitioning portion can be sealed on a side opposite to the holder by the seal portion.

(6) In the relay connector of any of (1) to (5), the holder held portion of at least one of the plurality of terminals may include a positioning protrusion, and the holder may include a positioning recess, the positioning protrusion being fit into the positioning recess.

In this way, even if the terminal does not include the bent portion or a bending angle of the bent portion thereof is small, the terminal is firmly held in the holder by fitting the positioning protrusion into the positioning recess.

(7) In the relay connector of any of (1) to (6), a circumferential groove may be formed in an outer periphery of the holder.

In this way, when a sealant is filled for the partitioning portion on the first connector housing portion side or the second connector housing portion side, the sealant hardly flows along the outer periphery of the holder. In this way, the sealant is firmly filled and sealability is improved.

(8) In the relay connector of any of (1) to (7), the press-fit portion may be a part formed to be partially thick near the holder held portion, out of the inserting portion.

In this case, the press-fit portion is inserted into the insertion hole in a final stage of inserting the inserting portion into the insertion hole. Thus, the inserting portion can be easily inserted into the insertion hole. Further, the terminal hardly comes out from the insertion hole with the press-fit portion press-fit in the insertion hole.

(9) In the relay connector of (8), the press-fit portion may be formed at a position to be press-fit into the insertion hole with the holder partially inserted in the holder recess.

In this way, the press-fit portion is press-fit into the insertion hole with the holder partially inserted in the holder recess. Thus, in press-fitting the press-fit portion into the insertion hole, the holder is further inserted into the holder recess and is hardly disassembled. In this way, the inserting portion, particularly the press-fit portion, can be inserted into the insertion hole by pushing the holder with the holder held portion firmly held by the holder.

### Details of Embodiment of Present Disclosure

A specific example of a relay connector of the present disclosure is described below with reference to the drawings. Note that the present disclosure is not limited to these illustrations, but is represented by claims and intended to include all changes in the scope of claims and in the meaning and scope of equivalents.

### Embodiment

### <Concerning Overall Configuration of Relay Connector>

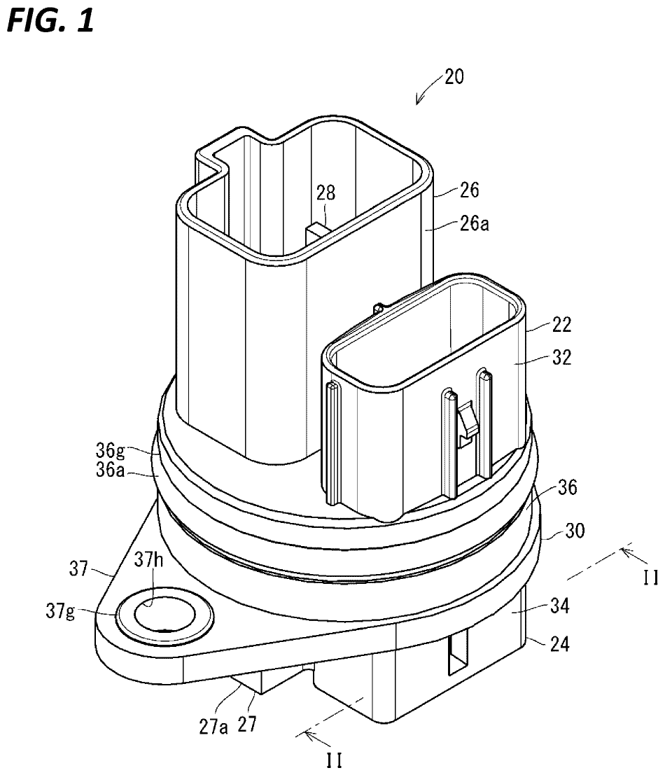

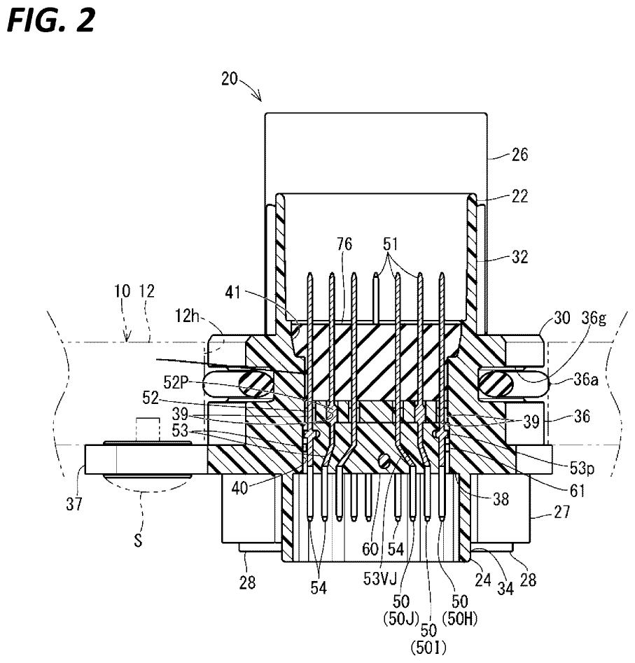

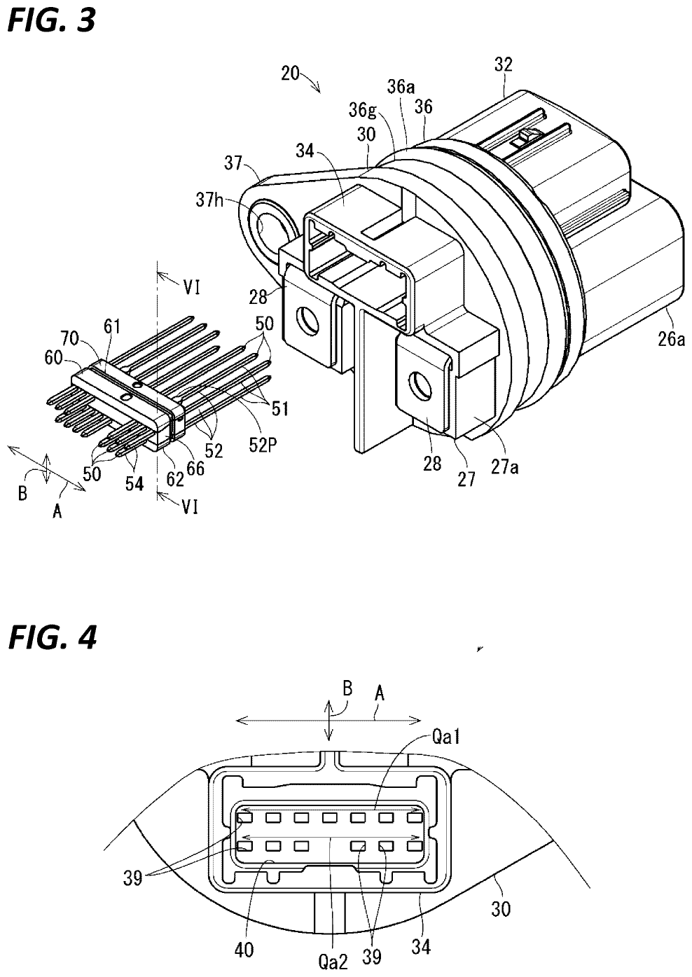

Hereinafter, a relay connector according to an embodiment is described. FIG. 1 is a perspective view showing a relay connector 20, and FIG. 2 is a section along II-II of FIG. 1. FIG. 3 is a perspective view showing a state before terminals 50 and a holder 60 are assembled with a connector housing 30.

The relay connector 20 is mounted on a case 12 of a device 10. For example, a through hole 12h is formed in the case 12, and the relay connector 20 is arranged through the through hole 12h. The relay connector 20 includes a first connector portion 22 and a second connector portion 24 and it is supposed that the first connector portion 22 is facing the outside of the device 10 and the second connector portion 24 is facing the inside of the device 10. A connector on an end part of a wiring harness outside the device 10 is connected to the first connector portion 22, and an electrical component or a connector of an internal wiring harness in the device 10 is connected to the second connector portion 24. In this way, the connectors inside and outside the device 10 are connected via the relay connector 20.

The device 10 is supposed as a device in which oil for lubrication or cooling is sealed. An example of such a device 10 is a transmission device in a vehicle. Oil for lubrication for smoothing movements of gears is thought to be sealed in the transmission device.

The relay connector 20 is provided with the connector housing 30, a plurality of the terminals 50 and the holder 60. The connector housing 30 is a resin part functioning as housings of the first and second connector portions 22, 24, a part for closing the through hole 12h and a part for holding the plurality of terminals 50 in a mutually insulated state. The plurality of terminals 50 are metal parts functioning as terminals of the first and second connector portions 22, 24 and relay connecting portions connecting the terminals on both ends. The holder 60 is a part functioning to hold the plurality of terminals 50 in the connector housing 30. Note that the relay connector 20 may be provided with terminals to be press-fit without being held by the holder 60.

In this embodiment, the relay connector 20 is provided with a first power supply connector portion 26 and a second power supply connector portion 27, separately from the first and second connector portions 22, 24. One end part of a power supply terminal 28 is exposed on the side of the first power supply connector portion 26, and the other end side thereof is exposed on the side of the second power supply connector portion 27. A power supply connector of a wiring harness outside the device 10 is connected to the first power supply connector portion 26, and an electrical component or a power supply connector of an internal wiring harness in the device 10 is connected to the second power supply connector portion 27, whereby the connectors inside and outside the device 10 are connected.

The first and second connector portions 22, 24 are located adjacent to the first and second power supply connector portions 26, 27. In this embodiment, the first and second connector portions 22, 24 are mainly described.

The connector housing 30 is, for example, a component molded using a resin. The connector housing 30 is provided with a first connector housing portion 32, a second connector housing portion 34 and an intermediate housing portion 36.

The intermediate housing portion 36 is shaped to close the through hole 12h. In this embodiment, the intermediate housing portion 36 is formed into a short cylindrical shape. A circumferential groove 36g is formed in the outer periphery of the intermediate housing portion 36. An annular resilient ring 36a made of rubber or the like is fit into the circumferential groove 36g. With the intermediate housing portion 36 arranged in the through hole 12h, the annular resilient ring 36a can be held in close contact with the inner peripheral surface of the through hole 12h. In this way, the annular resilient ring 36a seals between an outer peripheral part of the intermediate housing portion 36 and an inner peripheral part of the circumferential groove 36g.

A screw fastening piece 37 projects on the outer periphery of the intermediate housing portion 36. The screw fastening piece 37 is in the form of a plate extending along a direction parallel to an axis of the intermediate housing portion 36. The screw fastening piece 37 is formed with a screw insertion hole 37h. For example, a metal collar 37g is mounted into the screw fastening piece 37, and a hole in the metal collar 37g serves as the screw insertion hole 37h. With the intermediate housing portion 36 arranged in the through hole 12h, the screw fastening piece 37 is arranged in contact with a principle surface of the case 12. In this state, a screw S is inserted into the screw insertion hole 37h and threadably fastened to a screw on the side of the case 12, whereby the relay connector 20 is fixed to the case 12. The screw may be threadably fastened to a net in the case 12 through the through hole of the case 12 and the screw insertion hole 37h.

The first connector housing portion 32 projects on a surface of the intermediate housing portion 36 facing the outside of the device 10.

The first connector housing portion 32 has a tubular shape. In this embodiment, the first connector housing portion 32 is in the form of a rectangular tube long along a predetermined terminal array direction A. Corner parts of the rectangular tube are rounded into curved surfaces.

A part forming a housing 26a of the first power supply connector portion 26 projects on the surface of the intermediate housing portion 36 facing the outside of the device 10. One end parts of the power supply terminals 28 (the one end part of the power supply terminal 28 is partly shown in FIG. 1) are arranged in the part forming the housing 26a of the first power supply connector portion 26.

The second connector housing portion 34 projects on a surface of the intermediate housing portion 36 facing the inside of the device 10.

The second connector housing portion 34 has a tubular shape. In this embodiment, the second connector housing portion 34 is in the form of a rectangular tube long along the predetermined terminal array direction A as shown in FIG. 4. Corner parts of the rectangular tube are rounded into curved surfaces.

A base part of the first connector housing portion 32 and that of the second connector housing portion 34 are positioned to face each other via the intermediate housing portion 36. Here, when viewed along a thickness direction of the intermediate housing portion 36, one of the first and second connector housing portion 32, 34 is located in a region enclosed by the other. In this embodiment, a width and a height of the second connector housing portion 34 are smaller than those of the first connector housing portion 32. Thus, when viewed along the thickness direction of the intermediate housing portion 36, the second connector housing portion 34 is enclosed in a presence region of the first connector housing portion 32. Note that the thickness direction of the intermediate housing portion 36 is a direction coupling the first and second connector housing portions 32, 34.

A part forming a housing 27a of the second power supply connector portion 27 projects on the surface of the intermediate housing portion 36 facing the inside of the device 10. The other end parts of the power supply terminals 28 are supported in the part forming the housing 27a of the second power supply connector portion 27 (see FIG. 3).

Note that the first and second power supply connector portions 26, 27 may be omitted.

A partitioning portion 38 is located between the first and second connector housing portions 32, 34. In this embodiment, a part of the intermediate housing portion 36 located between the first and second connector housing portions 32, 34 is the partitioning portion 38 (see FIG. 2).

FIG. 4 shows the partitioning portion 38 when viewed from an opening side of the second connector housing portion 34.

As shown in FIGS. 1 to 4, the partitioning portion 38 includes a plurality of insertion holes 39 and a holder recess 40.

More specifically, the partitioning portion 38 includes a plate-like part partitioning between the first and second connector housing portions 32, 34, and this plate-like part is formed with the plurality of insertion holes 39. The plurality of insertion holes 39 are provided to correspond to the plurality of terminals 50. The insertion hole 39 penetrates between the first and second connector housing portions 32, 34. That is, the insertion hole 39 includes an opening facing the inside of the first connector housing portion 32 and an opening facing the inside of the second connector housing portion 34. The insertion hole 39 extends straight so that a straight part of the terminal 50 can be inserted thereinto.

The insertion hole 39 may be an angular hole or a round hole. In this embodiment, the insertion hole 39 is an angular hole having a rectangular cross-section orthogonal to an extension direction. The insertion hole 39 may be a hole whose size changes along a longitudinal direction or may be a hole with a fixed size.

The holder recess 40 is formed on a side of the partitioning portion 38 closer to the second connector housing portion 34 than the plurality of insertion holes 39. The holder recess 40 is recessed in a region larger than a presence region of the openings of the plurality of insertion holes 39 on the side of the second connector housing portion 34. The plurality of insertion holes 39 are open in a bottom part of the holder recess 40.

In this embodiment, as shown in FIG. 2, a seal recess 41 is formed on a side of the partitioning portion 38 closer to the first connector housing portion 32 than the plurality of insertion holes 39. The seal recess 41 is recessed in a region larger than a presence region of the openings of the plurality of insertion holes 39 on the side of the first connector housing portion 32. The plurality of insertion holes 39 are open in a bottom part of the seal recess 41. In this embodiment, the seal recess 41 is deeper than the holder recess 40, but this is not essential.

A seal portion 76 is filled into the seal recess 41. The seal portion 76 is a member for filling around the terminals 50 projecting toward the inside of the first connector housing portion 32 from the partitioning portion 38. The seal portion 76 is, for example, formed by filling a potting material such as polyurethane into the seal recess 41 and solidifying the potting material. The seal portion 76 may be called a potting seal portion. The seal portion 76 may be made of thermoplastic resin or the like that is softened by heat.

The terminal 50 is an elongated metal member formed, such as by press-working a metal plate. The terminal 50 may be formed, such as by bending or press-working a metal bar or a metal wire.

The terminal 50 is an elongated member formed such that a first terminal portion 51, an inserting portion 52, a holder held portion 53 and a second terminal portion 54 are arranged in this order.

The inserting portion 52 is a part to be inserted into the insertion hole 39. The inserting portion 52 is formed to be straight. A length of the inserting portion 52 is set to be equal to that of the insertion hole 39. The thickness of the inserting portion 52 is smaller than or equal to that of the insertion hole 39 within such a range that the inserting portion 52 is insertable into the insertion hole 39. The thickness of the inserting portion 52 may be slightly larger than the insertion hole 39 within such a range that the inserting portion 52 can be press-fit into the insertion hole 39.

The first terminal portion 51 extends further toward the first connector housing portion 32 than the inserting portion 52 along a straight extension of the inserting portion 52. In this embodiment, the first terminal portion 51 also extends straight. A base end part of the first terminal portion 51 is located in the seal recess 41 and a tip part thereof is located in the first connector housing portion 32. By fitting the seal portion 76 into the seal recess 41, the seal portion 76 closes around the base end parts of the first terminal portions 51, particularly closes the openings of the insertion holes 39 on the side of the first connector housing portion 32.

The tip part of the first terminal portion 51 extends toward the inside of the first connector housing portion 32 from a surface of the seal portion 76 facing the inside of the first connector housing portion 32. In this way, the first terminal portion 51 functions as a connector terminal of the first connector portion 22. That is, if a mating connector is inserted into the first connector housing portion 32, the tip parts of the first terminal portions 51 are inserted into terminals (here, female terminal parts) in the mating connector.

The holder held portion 53 is a part extending into the holder recess 40 from the inserting portion 52. The holder held portion 53 is held by the holder 60 in the holder recess 40.

The second terminal portion 54 is a part extending toward the second connector housing portion 34 from the holder held portion 53. In this embodiment, the second terminal portion 54 is a straight part extending toward the inside of the second connector housing portion 34 from a surface of the holder 60 facing toward the second connector housing portion 34. The second terminal portion 54 functions as a connector terminal of the second connector portion 24. That is, if a mating connector is inserted into the second connector housing portion 34, tip parts of the second terminal portions 54 are inserted into terminals (here, female terminal parts) in the mating connector.

The holder 60 is accommodated into the holder recess 40 while holding the holder held portions 53 of the plurality of terminals 50.

### <Concerning Array and Shapes of Terminals>

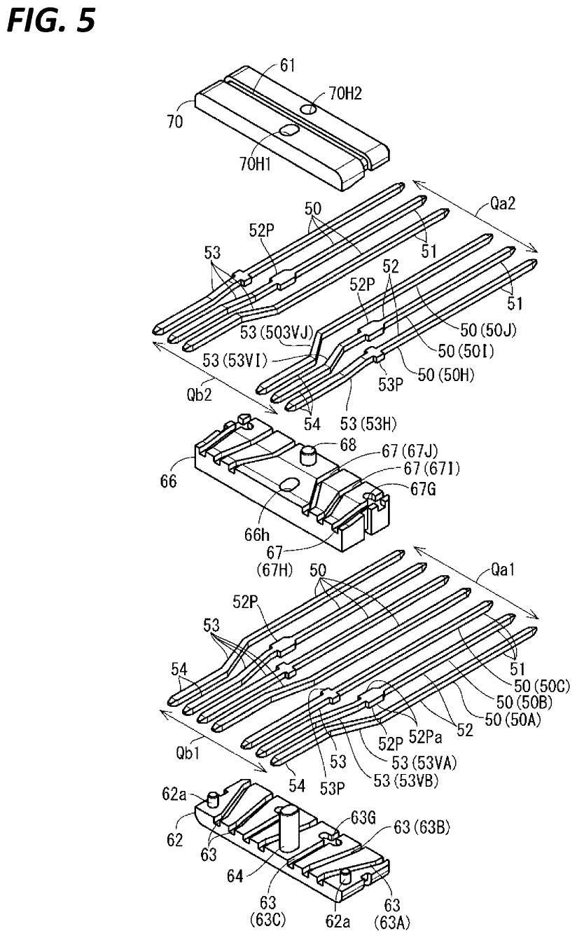

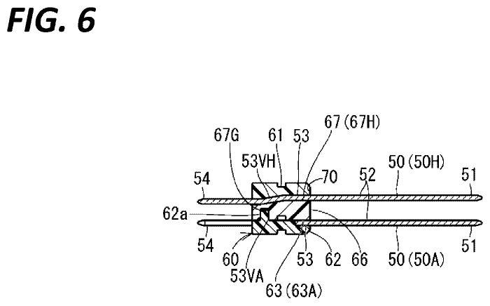

FIG. 5 is an exploded perspective view of the terminals 50 and the holder 60. FIG. 6 is a section along VI-VI of FIG. 3.

As shown in FIGS. 2, 3, 5 and 6, the plurality of inserting portions 52 corresponding to the plurality of terminals 50 are arranged in a row or a plurality of rows along the terminal array direction A.

That is, the plurality of insertion holes 39 are arranged in a row or a plurality of rows along the terminal array direction A in the partitioning portion 38. In this embodiment, the plurality of insertion holes 39 are formed side by side in two rows (see FIG. 4). In each of a first row Qa1 and a second row Qa2, a plurality of the insertion holes 39 are formed side by side at intervals. In the first row Qa1, a plurality of (here, seven) the insertion holes 39 are arranged at equal intervals. In the second row Qa2, a plurality of (here, six) the insertion holes 39 are separated on left and right sides. In each of the left and right sides, a plurality of (here, three) the insertion holes 39 are arranged at equal intervals. An interval between the insertion holes 39 in a center in the terminal array direction A is larger than the intervals between the insertion holes 39 on the left and right sides.

In this embodiment, the formation positions of the plurality of insertion holes 39 in the second row Qa2 are obtained by omitting some (here, a center position) of the formation positions of the plurality of insertion holes 39 in the first row Qa1. Thus, in the terminal array direction A, the interval of the plurality of insertion holes 39 in the second row Qa2 is equal to that of the plurality of insertion holes 39 in the first row Qa1 except the center interval corresponding to the omitted position (see FIG. 3).

The inserting portion 52 of each of the plurality of terminals 50 is inserted into the corresponding insertion hole 39. Thus, the array positions of the plurality of insertion holes 39 specify those of the inserting portions 52 of the plurality of terminals 50. In this embodiment, the first terminal portion 51 extends straight from the inserting portion 52. Thus, the array positions of the plurality of insertion holes 39 specify those of the plurality of first terminal portions 51 in the first connector portion 22. That is, the array positions of the plurality of insertion holes 39 are the same as those of the plurality of first terminal portions 51.

The plurality of second terminal portions 54 in the second connector portion 24 are arranged in a row or a plurality of rows along the terminal array direction A. The array positions of the plurality of second terminal portions 54 are different from those of the first terminal portions 51. Specifically, the plurality of second terminal portions 54 are arranged in two rows along the terminal array direction A (see FIG. 3). In each of a first row Qb1 and a second row Qb2, a plurality of the second terminal portions 54 are arranged side by side at intervals. The arrangement positions of the first terminal portions 51 in the first row Qa1 and those of the second terminal portions 54 in the first row Qb1 are the same in a direction B orthogonal to both the terminal array direction A and the inserting portions 52, i.e. in the direction B connecting the first row Qb1 and the second row Qb2. Thus, when viewed along the terminal array direction A, the second terminal portions 54 arranged along the first row Qb1 are located on straight extensions of the first terminal portions 51 arranged along the first row Qa1.

The arrangement positions of the first terminal portions 51 in the first row Qa2 and those of the second terminal portions 54 in the first row Qb2 are different in the direction B orthogonal to both the terminal array direction A and the inserting portions 52. Here, the arrangement positions of the second terminal portions 54 in the second row Qb2 are set closer to the first row Qb1 than the arrangement positions of the first terminal portions 51 in the second row Qa2. Thus, when viewed along the terminal array direction A, the terminal portion 54 is bent to be shifted toward the first row Qb1 while extending from the first terminal portion 51 arranged along the second row Qa2 toward the second terminal portion 54 arranged along the second row Qb2.

Further, an overall width of the plurality of second terminal portions 54 arranged along the first row Qb1 is smaller than that of the plurality of first terminal portions 51 arranged along the first row Qa1 (see FIG. 5). Further, the plurality of second terminal portions 54 arranged along the first row Qb1 are arranged to have a largest interval in the middle and equal intervals at a plurality of other positions. Thus, the positions of the first terminal portions 51 and those of the second terminal portions 54 of the respective terminals 50 arranged along the first rows Qa1, Qb1 may be different along the terminal array direction A.

An overall width of the plurality of second terminal portions 54 arranged along the first row Qb2 is equal to that of the plurality of first terminal portions 51 arranged along the first row Qa2 (see FIG. 5). However, the intervals of the plurality of second terminal portions 54 in the second row Qb1 are different from those of the plurality of first terminal portions 51 in the second row Qa2. Here, the interval of the plurality of second terminal portions 54 in a center of the second row Qb2 is larger than the interval of the plurality of first terminal portions 51 in a center of the second row Qa2. Further, the intervals of the second terminal portions 54 on left and right sides in the second row Qb2 are smaller than those of the first terminal portions 51 on left and right sides in the second row Qa2. Thus, the positions of the first terminal portions 51 and those of the second terminal portions 54 of the respective terminals 50 arranged along the second rows Qa2, Qb2 may be different along the terminal array direction A.

Note that the array positions of the first terminal portions 51 in the first connector portion 22 and those of the second terminal portions 54 in the second connector portion 24 are set depending on spaces where the respective connector portions 26, 27 can be arranged, spaces where the terminal portions 51, 54 can be arranged in the respective connector portions 26, 27, shape restrictions of the mating connectors, functions required for the respective connector portions 26, 27 (e.g. water stop performance, connection reliability). Thus, there is possibly a requirement to make the array positions of the first terminal portions 51 in the first connector portion 22 and those of the second terminal portions 54 in the second connector portion 24 different.

The holder held portion 53 of at least one of the plurality of terminals 50 includes a bent portion (e.g. bent portions 53VA, 53VB, 53VH, 53VI and 53VJ) bent with respect to the inserting portion 52. These bent portions (e.g. the bent portions 53VA, 53VB, 53VH, 53VI and 53VJ) can function as position converting bent portions bent to make the positions of the first terminal portions 51 in the first connector housing portion 32 and those of the second terminal portions 54 in the second connector housing portion 34 different.

Description is given, focusing on some of the plurality of terminals 50 arranged along the first rows Qa1, Qb1. Here, out of the plurality of terminals 50 arranged along the first rows Qa1, Qb1, three terminals 30 from the rightmost one when viewed from the opening of the second connector housing portion 34 are focused. For the sake of convenience, the three terminals 50 from the rightmost one may be distinguished as terminals 50A, 50B and 50C in that order.

The second terminal portion 54 of the terminal 50A is located closer to the centers of the first rows Qa1, Qb1 than the first terminal portion 51. Thus, the holder held portion 53 between the inserting portion 52 and the second terminal portion 54 of the terminal 50A includes the bent portion 53 VA bent toward the centers of the first rows Qa1, Qb1 along the first rows Qa1, Qb1 while extending from the inserting portion 52 toward the second terminal portion 54. The bent portion 53VA includes an intersecting direction portion extending in a direction intersecting both the first and second terminal portions 51, 54 between two corner parts. The two corner parts are, for example, parts bent at an angle of 90° or more. If the two corner parts have the same angle, the second terminal portion 54 can extend along the same direction as the first terminal portion 51 and the inserting portion 52. The intersecting direction portion may be orthogonal to the first and second terminal portions 51, 54 or may extend in an oblique direction. In this embodiment, the intersecting direction portion is at an obtuse angle to the first and second terminal portions 51, 54.

Similarly to the bent portion 53VA, the holder held portion 53 of the terminal 50B includes the bent portion 53VB. Angles of the bent portion 53VB to the first and second terminal portions 51, 54 are smaller than those of the bent portion 53VA to the first and second terminal portions 51, 54. This is because displacement amounts of the first and second terminal portions 51, 54 in the terminal 50B are smaller than those of the first and second terminal portions 51, 54 in the terminal 50A.

The holder held portion 53 of the terminal 50C extends straight without including a bent portion. This is because the first and second terminal portions 51, 54 in the terminal 50C are located at the same position in the terminal array direction A and the direction B orthogonal to the direction A.

The bent portions 53VA, 53VB are examples of an interval converting bent portion bent to make the positions of the first and second terminal portions 51, 54 different along the terminal array direction A.

The holder held portions 53 of the other terminals 50 arranged along the first rows Qa1, Qb1 are also provided with a bent portion matching the positions of the first and second terminal portions 51, 54 or extend straight without including the bent portion.

Description is given, focusing on some of the plurality of terminals 50 arranged along the first rows Qa2, Qb2. Here, out of the plurality of terminals 50 arranged along the first rows Qa2, Qb2, three terminals 30 from the rightmost one when viewed from the opening of the second connector housing portion 34 are focused. For the sake of convenience, the three terminals 50 from the rightmost one may be distinguished as terminals 50H, 50I and 50J in that order.

First, the second terminal portions 54 of the terminals 50H, 50I and 50J are located closer to the first row Qb1 than the first terminal portions 51 in the direction B orthogonal to the terminal array direction A.

Further, the second terminal portion 54 of the terminal 50H is located at the same position as the first terminal portion 51 in the terminal array direction A. Thus, the holder held portion 53 between the inserting portion 52 and the second terminal portion 54 of the terminal 50H includes the bent portion 53VH bent toward the first row Qa1 along the direction B while extending from the inserting portion 52 to the second terminal portion 54. The bent portion 53VH includes an intersecting direction portion extending in a direction intersecting both the first and second terminal portions 51, 54 between two corner parts. The two corner parts are, for example, parts bent at an angle of 90° or more. If the two corner parts have the same angle, the second terminal portion 54 can extend along the same direction as the first terminal portion 51 and the inserting portion 52. The intersecting direction portion may be orthogonal to the first and second terminal portions 51, 54 or may extend in an oblique direction. In this embodiment, the intersecting direction portion is at an obtuse angle to the first and second terminal portions 51, 54.

The bent portion 53VH is an example of an array position converting bent portion bent to make the positions of the first and second terminal portions 51, 54 different in the direction B intersecting the terminal array direction A.

Further, the second terminal portion 54 of the terminal 50I, 50J is located more outward in the second row Qb2 than the first terminal portion 51 in the terminal array direction A. Thus, the holder held portion 53 of the terminal 50I, 50J includes the bent portion 53VI, 53VJ bent toward the first row Qa1 along the direction B and outward in the second row Qb2 while extending from the inserting portion 52 toward the second terminal portion 54 according to a position difference between the first and second terminal portions 51, 54.

In this embodiment, the position difference between the first and second terminal portions 51, 54 of the terminal 50J is larger than that between the first and second terminal portions 51, 54 of the terminal 50I in the second row Qb2. Thus, the bent portion 53VJ is bent more than the bent portion 53VI.

Since being bent in the both directions A, B, the bent portions 53VI, 53VJ are examples of the interval converting bent portion and examples of the array position converting bent portion.

The holder held portions 53 of the other terminals 50 arranged along the first rows Qa1, Qb1 are also provided with a bent portion matching the positions of the first and second terminal portions 51, 54.

As described above, for each terminal 50, the difference between the array position of the first terminal portion 51 and that of the second terminal portion 54 can be dealt with by setting or not setting the bent portion 53VA, 53VB, 53VH, 53VI, 53VJ corresponding to the position differences between the first and second terminal portions 51, 54 in the directions A, B.

Further, the inserting portion 52 of at least one of the plurality of terminals 50 includes a press-fit portion 52P to be press-fit into the insertion hole 39. In this embodiment, the press-fit portions 52P are provided on the inserting portions 52 of some of the plurality of terminals 50, e.g. the terminals 50B, 50I.

The press-fit portion 52P is a part to be pressed against the inner peripheral surface of the insertion hole 39 in inserting the inserting portion 52 into the insertion hole 39. For example, it is supposed that a dimension in at least one direction orthogonal to an axis of the inserting portion 52 is set to be larger than that of the insertion hole 39.

The press-fit portion 52P may be set over the entire inserting portion 52 or may be set in a part of the inserting portion 52 in a longitudinal direction. The press-fit portion 52P is preferably a part formed to be partially thick near the holder held portion 53, out of the inserting portion 52. In this way, in an initial stage of insertion of the inserting portion 52, the inserting portion 52 can be smoothly inserted without the press-fit portion 52P entering the insertion hole 39. The press-fit portions 52P are preferably set on the terminals including the bent portions 53VA, 53VB, 53VH, 53VI and 53VI, but this is not essential. The press-fit portion 52P may be set on the terminal not including the bent portion.

The press-fit portion 52P is preferably formed at a position to be press-fit into the insertion hole 39 with the holder 60 partially inserted in the holder recess 40. In this way, a reaction force acting during press-fitting is more reliably received by the holder 60 held in a united state by the holder recess 40. In this way, the plurality of terminals 50 are easily press-fit and inserted.

In this embodiment, the press-fit portion 52P includes a pair of projecting pieces 52Pa projecting toward both outer sides from a part of the inserting portion 52 near the holder held portion 53. The outward facing surface of the projecting piece 52Pa extends along an axial direction of the inserting portion 52. An edge of the projecting piece 52Pa on the side of the first terminal portion 51 is formed into an inclined edge inclined inward toward the first terminal portion 51.

In inserting the inserting portion 52 including the press-fit portion 52P into the insertion hole 39, the inclined edges of the projecting pieces 52Pa contact the opening edge of the insertion hole 39 on the side of the second connector housing portion 34. In this way, the pair of projecting pieces 52Pa can be smoothly inserted into the insertion hole 39. A width between the outward facing surfaces of the pair of projecting pieces 52Pa is larger than a width of the insertion hole 39 to such an extent that the press-fit portion 52P can be press-fit. Thus, if the press-fit portion 52P is press-fit into the inserting portion 52, the insertion hole 39 is held in the insertion hole 39 by a friction force generated by pressing the pair of projecting pieces 52Pa against the inner peripheral surface of the insertion hole 39 or a locking force by the biting of the projecting pieces 52Pa.

The plurality of inserting portions 52 are inserted into the plurality of insertion holes 39 with the plurality of terminals 50 integrated by the holder 60. Thus, if the press-fit portion 52P of at least one of the plurality of inserting portions 52 is press-fit into the inserting portion 52 and retained and held, this holding force is applied to all the plurality of terminals 50 held by the holder 60. The press-fit portion 52P may be set on the terminal including the bent portion or may be set on the terminal 50 not including the bent portion. In this embodiment, the press-fit portions 50P are provided on a plurality of (here, four) terminals 50 including the terminals 50B, 50I having the bent portions 53VB, 53VI. On which of the plurality of terminals 50 the press-fit portions 52P should be set are appropriately set according to a force required to retain and hold the terminals 50. The number of the terminals 50, on which the press-fit portions 52P are set, may be increased as a larger retaining/holding force is required.

Further, the holder held portion 53 of at least one of the plurality of terminals 50 includes a positioning protrusion 53P. The positioning protrusion 53P is a part projecting outward from another part of the holder held portion 53. In this embodiment, the positioning protrusion 53P includes a pair of rectangular projecting pieces projecting on both sides of the holder held portion 53. By this positioning protrusion 53P, the holder held portion 53 is more reliably positioned and held by the holder 60.

It is supposed that the larger an angle of inclination of the bent portion 53VA, 53VB, 53VH, 53VI, 53VJ set in the holder held portion 53, the larger an effect of suppressing a position shift of the holder held portion 53 with respect to the holder 60. Thus, the positioning protrusions 53P are preferably set on the holder held portions 53 of the terminals 50 (e.g. the terminal 50C) having no bent portion set thereon and the holder held portion 53 of the terminal 50H including the bent portion (e.g. 53VH) having a small angle of inclination.

### <Concerning Holder>

The holder 60 is divided into a plurality of holder divided members 62, 66 and 70. In this embodiment, the holder 60 is provided with a first holder divided member 62, a second holder divided member 66 and a third holder divided member 70. Each of the first, second and third holder divided members 62, 66 and 70 is a member molded using a resin. The first, second and third holder divided members 62, 66 and 70 are stacked in this order along the direction B orthogonal to the terminal array direction A.

A plurality of the holder held portions 53 along the first row Qb1 are held between the first and second holder divided members 62, 66.

More specifically, a plurality of holding grooves 63 capable of accommodating the plurality of holder held portions 53 along the first row Qb1 are formed in a part facing the second holder divided member 66, out of the first holder divided member 62. The plurality of holding grooves 63 are open on both sides facing the partitioning portion 38 and the second connector housing portion 34 and formed into groove shapes bent according to the plurality of holder held portions 53 along the first row Qb1. For example, the holding grooves 63A, 63B for holding the holder held portions 53 including the bent portions 53VA, 53VB are formed into shapes bent according to the bent portions 53VA, 53VB. The holding groove 63C for holding the holder held portion 53 not including the bent portion is formed as a groove extending straight.

No grooves are formed in a part facing the first holder divided member 62, out of the second holder divided member 66, and this part is formed to press the holder held portions 53 into the holding grooves 63. Grooves for partially accommodating the holder held portions 53 may be formed also in the part facing the first holder divided member 62, out of the second holder divided member 66.

In a relationship of the first and second holder divided members 62, 66, the first holder divided member 62 is an example of a grooved holder member including the holding grooves 63 and the second holder divided member 66 is an example of a lid holder member for holding the plurality of holder held portions 53 accommodated in the plurality of holding grooves 63 by being united with the first holder divided member 62 serving as the grooved holder member.

A plurality of the holder held portions 53 along the second row Qb2 are held between the second and third holder divided members 66, 70.

More specifically, a plurality of holding grooves 67 capable of accommodating the plurality of holder held portions 53 along the second row Qb2 are formed in a part facing the third holder divided member 70, out of the second holder divided member 66. The plurality of holding grooves 67 are open on both sides facing the partitioning portion 38 and the second connector housing portion 34 and formed into groove shapes bent according to the plurality of holder held portions 53 along the second row Qb2. For example, the holding groove 67H for holding the holder held portion 53 including the bent portion 53VH is formed into a shape bent according to the bent portion 53VH. The holding grooves 67I, 67J for holding the holder held portions 53 including the bent portions 53VI, 53VJ are formed into shapes bent in the directions A and B according to the bent portions 53VI, 53VJ.

No grooves are formed in a part facing the second holder divided member 66, out of the third holder divided member 70, and this part is formed to press the holder held portions 53 into the holding grooves 67. Grooves for partially accommodating the holder held portions 53 may be formed also in the part facing the second holder divided member 66, out of the third holder divided member 70.

In a relationship of the second and third holder divided members 66, 70, the second holder divided member 66 is an example of a grooved holder member including the holding grooves 67 and the third holder divided member 70 is an example of a lid holder member for holding the plurality of holder held portions 53 accommodated in the plurality of holding grooves 67 by being united with the second holder divided member 66 serving as the grooved holder member.

The holder 60 includes positioning recesses 63G, 67G, into which the positioning protrusions 53P are fit. In this embodiment, the positioning recesses 63G, 67G are formed which are recessed outward on both sides from parts of the holding grooves 63C, 67J near the partitioning portion 38. In fitting the holder held portions 53 into the holding grooves 63C, 67J, the positioning protrusions 53P are fit into the positioning recesses 63G, 67G, whereby the holder held portions 53 are hardly shifted in position along longitudinal directions of the holding grooves 63C, 67J.

The first holder divided member 62 is formed with a uniting protrusion 64, and the second holder divided member 66 is formed with a uniting protrusion 68. The second and third holder divided members 66, 70 are formed with uniting holes 66h, 70h1, into which the uniting protrusion 64 is inserted. Preferably, the uniting protrusion 64 is sized to be press-fit into the uniting holes 66h, 70h1. The third holder divided member 70 is formed with a uniting hole 70h2, into which the uniting protrusion 68 is inserted. Preferably, the uniting protrusion 68 is press-fit into the uniting hole 70h2.

With the first, second and third holder divided members 62, 66 and 70 stacked, the uniting protrusion 64 is inserted into the uniting holes 66h, 70h1 and the uniting protrusion 68 is inserted into the uniting hole 70h2. In this way, the first, second and third holder divided members 62, 66 and 70 are united while being suppressed from being shifted in position.

Note that positioning protrusions 62a are provided to project near both sides of the surface of the first holder divided member 62 on the side of the second holder divided member 66. The first and second holder divided members 62, 66 are positioned also by fitting these positioning protrusions 62a into positioning recesses (see FIG. 5) formed in the surface of the second holder divided member 66 on the side of the first holder divided member 62.

In a united state of the first, second and third holder divided members 62, 66 and 70, the holder 60 is in the form of a rectangular column with rounded corners on an outer periphery. Dimensions of the holder 60 in the terminal array direction A and the direction B orthogonal to the direction A match dimensions in the holder recess 40 to such an extent that the holder 60 can be accommodated in the holder recess 40 without rattling. Preferably, the holder 60 may be sized to be press-fit into the holder recess 40. A length of the holder 60 in a direction orthogonal to the both directions A, B is set such that the entire holder 60 is accommodated in the holder recess 40. With the holder 60 accommodated in the holder recess 40, rattling in the directions A, B is suppressed and the above united state is maintained. The holder 60 is accommodated in the holder recess 40 with the plurality of holder held portions 53 held in the plurality of holding grooves 63, 67. In this state, at least one of the press-fit portions 52P inserted into the plurality of insertion holes 39 is press-fit in the insertion hole 39.

A circumferential groove 61 is formed in the outer periphery of the holder 60. The circumferential groove 61 is, for example, a groove formed around the outer periphery of the holder 60. For example, even if the potting material for forming the seal portion 76 flows into between the holder recess 40 and the holder 60, the flowing-in potting material can flow into the circumferential groove 61. In this way, it is suppressed that the potting material reaches the inside of the second connector housing portion 34.

Note that an edge of an end part of the holder 60 on the side of the partitioning portion 38 is preferably formed into a guide surface inclined inward toward the partitioning portion 38. Further, the opening of the holder recess 40 on the side of the second connector housing portion 34 is preferably formed into a guide surface inclined outward toward the second connector housing portion 34. In this way, the holder 60 can be easily press-fit into the holder recess 40.

### <Concerning Assembly Procedure>

An example of an assembly procedure of the relay connector 20 is described.

The plurality of terminals 50, the first holder divided member 62, the second holder divided member 66 and the third holder divided member 70 are prepared.

The plurality of holder held portions 53 arranged along the first row Qb1 are accommodated into the plurality of holding grooves 63 of the first holder divided member 62. Then, the second holder divided member 66 is placed on the first holder divided member 62 while the uniting protrusion 64 is inserted into the uniting hole 66h. In this way, the plurality of holder held portions 53 are held in the plurality of holding grooves 63.

After or before the above process, the plurality of holder held portions 53 arranged along the first row Qb2 are accommodated into the plurality of holding grooves 67 of the second holder divided member 66. Then, the third holder divided member 70 is placed on the second holder divided member 66 while the uniting protrusions 64, 68 are inserted into the uniting holes 70h1, 70h2. In this way, the plurality of holder held portions 53 are held in the plurality of holding grooves 67.

With the plurality of terminals 50 held by the holder 60, the plurality of first terminal portions 51 are inserted into the plurality of insertion holes 39 from the opening side of the second connector housing portion 34. With the first terminal portions 51 inserted in the seal recess 41 and the first connector housing portion 32, a tip part of the holder 60 enters the holder recess 40. If the holder 60 enters the holder recess 40, the holder 60 is surrounded by the inner peripheral surface of the holder recess 40, wherefore the first, second and third holder divided members 62, 66 and 70 are kept in the stacked state and the disassembly of those is suppressed.

Note that the relatively large interval is provided between central ones of the second terminal portions 54 arranged along the second row Qb2. Thus, the holder 60 can be easily pushed in, using a surface of the holder 60 facing in a direction opposite to a push-in direction and in the interval between the second terminal portions 54 arranged along the second row Qb2.

The holder 60 is further pushed into the holder recess 40 with the disassembly of the holder 60 suppressed. Then, the press-fit portions 52P are press-fit into the insertion holes 39. At this time, a reaction force to press-fitting acts between the holder 60 and the holder held portions 53. Out of the holder held portions 53 including the bent portions 53VA, 53VB, 53VH, 53VI and 53VJ, parts intersecting the push-in direction are fit and held in the holding grooves 63, 67. Thus, the reaction force to press-fitting is effectively received by the holding grooves 63, 67 holding the bent portions 53VA, 53VB, 53VH, 53VI and 53VJ. In this way, the press-fit portions 52P can be effectively inserted into the insertion holes 39 and the bent portions 53VA, 53VB, 53VH, 53VI and 53VJ are hardly deformed in the holding grooves 63 while position shifts of the holder held portions 53 with respect to the holder 60 are suppressed.

Further, the holder held portions 53 including the positioning protrusions 53P are held with the positioning protrusions 53P fit in the positioning recesses 63G, 67G. Thus, the reaction force to press-fitting is effectively received by a fitting structure for fitting the positioning protrusions 53P into the positioning recesses 63G, 67G. In this way, the press-fit portions 52P can be effectively inserted into the insertion holes 39 and the holder held portions 53 are hardly shifted in position with respect to the holder 60.

If the holder 60 is inserted to the back of the holder recess 40, the first terminal portions 51 are arranged at predetermined positions in the first connector housing portion 32 and the first connector portion 22 can function. Further, the second terminal portions 54 are arranged at predetermined positions in the second connector housing portion 34 and the second connector portion 24 can function.

Further, the potting material or the like is filled into the seal recess 41 to form the seal portion 76. Note that the potting material possibly flows into the second connector housing portion 34 along the terminals 50 and the holder 60.

The inflow of the potting material along the terminals 50 can be suppressed, such as by the press-fit portions 52P and the positioning protrusions 53P projecting from the terminals 50 and a configuration in which the holding grooves 63, 67 are held in as close contact as possible with the holder held portions 53. The inflow of the potting material along the outer periphery of the holder 60 is suppressed by the potting material flowing into and dammed by the circumferential groove 61.

By forming the seal portion 76 in the seal recess 41, the relay connector 20 is assembled.

### <Effects, etc.>

According to the relay connector 20 configured as described above, the inserting portions 52 can be inserted into the insertion holes 39 and at least one press-fit portion 52P can be press-fit in the insertion hole 39 with the holder 60 holding the holder held portions 53 in the holding grooves 63, 67. Thus, the bent portions 53VA, 53VB, 53VH, 53VI and 53VJ are hardly deformed during the press-fitting of the terminals 50. Further, the bent portions 53VA, 53VB, 53VH, 53VI and 53VJ are held in the holding grooves 63, 67 of the holder 60 in the holder recess 40 with the inserting portions 52 press-fit in the inserting portions 52. Thus, even if another connector is connected to the first connector portion 21 or the second connector portion 22 and a force acts on the first terminal portions 51 or the second terminal portions 54 along the longitudinal direction thereof, the bent portions 53VA, 53VB, 53VH, 53VI and 53VJ are hardly deformed. Thus, also in a used state after the completion of the relay connector 20, the bent portions 53VA, 53VB, 53VH, 53VI and 53VJ are hardly deformed. Therefore, the deformation of the bent portions 53VA, 53VB, 53VH, 53VI and 53VJ set in the intermediate parts of the terminals can be suppressed in the relay connector 20 of the type that the terminals 50 are press-fit.

Further, if the plurality of terminals are insert components in molding the connector housing, the precise alignment adjustment of the plurality of terminals is possibly difficult. In this embodiment, the plurality of terminals 50 can be positioned and held by the molded insertion holes 39 and the holding grooves 63, 67 of the holder 60. Thus, the manufacturing of the relay connector 20 is easy and effects of improving productivity and reducing manufacturing cost can be obtained.

Further, the positions of the first terminal portions 51 in the first connector housing portion 32 and those of the second terminal portions 54 in the second connector housing portion 34 can be made different by the bent portions 53VA, 53VB, 53VH, 53VI and 53VJ serving as the position converting bent portions.

Further, the positions of the first terminal portions 51 and the second terminal portions 54 can be made different along the terminal array direction A by the bent portions 53VA, 53VB, 53VI and 53VJ serving as the interval converting bent portions. In this way, the arrangement intervals of the first terminal portions 51 and those of the second terminal portions 54 can be changed.

Further, the array positions of the first terminal portions 51 and those of the second terminal portions 54 in the direction B can be changed by making the positions of the first and second terminal portions 51, 54 different in the direction intersecting the terminal array direction A by the bent portions 53VH, 53VI and 53VJ serving as the array position converting bent portions.

Further, the partitioning portion 38 includes the seal recess 41 on the side closer to the first connector housing portion 32 than the inserting portions 52, and the seal portion 76 is filled and arranged in the seal recess 41. Thus, the partitioning portion 38 can be sealed on the side opposite to the holder 60 by the seal portion 76. In this way, there are less joints of the members and the like on the side opposite to the side where the holder 60 is present, wherefore sealability is improved by sealing on the side opposite to the holder 60.

Here, if the seal portion 76 made of the potting material or the like and the holder 60, which is a resin molded component, are compared, the holder 60 is supposedly better in oil resistance. If the holder 60 is inside the device 10 and the seal portion 76 is outside the device 10, the seal portion 76 is hardly exposed to oil and sealability by the seal portion 76 is satisfactorily maintained.

Further, if at least one holder held portion 53 includes the positioning protrusion 53P and the holder 60 includes the positioning recess 63G, 67G, into which the positioning protrusion 53P is fit, this terminal 50 (e.g. the terminal 50C, 50H) is firmly held in the holder 60 even if the terminal 50 does not include the bent portion or a bending angle of the bent portion thereof is small.

Further, since the circumferential groove 61 is formed in the outer periphery of the holder 60, a sealant such as the potting material for forming the seal portion 76 hardly flows along the outer periphery of the holder 60. In this way, the sealant is firmly filled and sealability is improved.

Further, since the press-fit portion 52P is a part formed to be partially thick near the holder held portion 53, out of the inserting portion 52, the press-fit portion 52P is press-fit into the insertion hole 39 in a final stage of inserting the inserting portion 52 into the insertion hole 39. Thus, it is not necessary to apply a press-fit force during the entire insertion time of the inserting portion 52 into the insertion hole 39, and the inserting portion 52 can be easily inserted into the insertion hole 39. Further, the terminal 50 hardly comes out from the insertion hole 39 with the press-fit portion 52P press-fit in the insertion hole 39.

Further, since the press-fit portions 52P are press-fit into the insertion holes 39 with the holder 60 partially inserted in the holder recess 40, the holder 60 is inserted into the holder recess 40 and hardly disassembled when the press-fit portions 52P are press-fit into the insertion holes 39. In this way, the holder 60 can be pushed in and the press-fit portions 52P can be press-fit into the insertion holes 39 with the holder held portions 53 firmly held by the holder 60.

Note that the respective configurations described in the above embodiment and modifications can be combined as appropriate without contradicting each other.

### LIST OF REFERENCE NUMERALS

10 device
12 case
12h through hole
20 relay connector
22 first connector portion
24 second connector portion
26 first power supply connector portion
26a housing
27 second power supply connector portion
27a connector base
28 power supply terminal
30 connector housing
32 first connector housing portion
34 second connector housing portion
36 intermediate housing portion
36a annular resilient ring
36g circumferential groove
37 screw fastening piece
37g metal collar
37h screw insertion hole
38 partitioning portion
39 insertion hole
40 holder recess
41 seal recess
50 (50A, 50B, 50C, 50H, 50I, 50J) terminal
51 first terminal portion
52 inserting portion
52P press-fit portion
52Pa projecting piece
53 holder held portion
53P positioning protrusion
53VA, 53VB, 53VH, 53VI, 53VJ bent portion
54 second terminal portion
60 holder
61 circumferential groove
62 first holder divided member
62a positioning protrusion
63 (63A, 63B, 63C), 67 (67H, 67I, 67J) holding groove
63G, 67G positioning recess
64, 68 uniting protrusion
66 second holder divided member
66h, 70h1, 70h2 uniting hole
70 third holder divided member
76 seal portion
A terminal array direction
B direction orthogonal to terminal array direction
Qa1, Qb1 first row
Qa2, Qb2 second row
S screw

1. A relay connector, comprising:
a connector housing including a first connector housing portion, a second connector housing portion and a partitioning portion between the first connector housing portion and the second connector housing portion;
a plurality of terminals; and
a holder for holding the plurality of terminals,
the partitioning portion including a plurality of insertion holes, the plurality of terminals being respectively inserted into the plurality of insertion holes, and a holder recess for accommodating the holder on a side closer to the second connector housing portion than the plurality of insertion holes,
each of the plurality of terminals including an inserting portion to be inserted into the insertion hole, a first terminal portion extending further toward the first connector housing portion than the inserting portion along an extension of the inserting portion, a holder held portion extending into the holder recess from the inserting portion, and a second terminal portion extending toward the second connector housing portion from the holder held portion,
the inserting portion of at least one of the plurality of terminals including a press-fit portion to be press-fit into the insertion hole,
the holder held portion of at least one of the plurality of terminals including a bent portion bent with respect to the inserting portion,
the holder including a grooved holder member having a plurality of holding grooves capable of accommodating the plurality of holder held portions and a lid holder member for holding the plurality of holder held portions in a state accommodated in the plurality of holding grooves by being united with the grooved holder member, and
the holder being accommodated in the holder recess and the press-fit portion of the at least one inserting portion being press-fit in the insertion hole by inserting the plurality of inserting portions into the plurality of insertion holes with the holder holding the plurality of holder held portions in the plurality of holding grooves.

2. The relay connector of claim 1, wherein the bent portion of the at least one holder held portion includes a position converting bent portion bent to make a position of the first terminal portion in the first connector housing portion and a position of the second terminal portion in the second connector housing portion different.

3. The relay connector of claim 1, wherein:
the plurality of inserting portions are arranged in a row or a plurality of rows along a terminal array direction, and
the bent portion of the at least one holder held portion includes an interval converting bent portion bent to make positions of the first terminal portion and the second terminal portion different along the terminal array direction.

4. The relay connector of claim 1, wherein:
the plurality of inserting portions are arranged in a row or a plurality of rows along a terminal array direction, and
the bent portion of the at least one holder held portion includes an array position converting bent portion bent to make positions of the first terminal portion and the second terminal portion different in a direction intersecting the terminal array direction.

5. The relay connector of claim 1, wherein:
the partitioning portion includes a seal recess on a side closer to the first connector housing portion than the insertion holes, and
the relay connector further comprises a seal portion filled in the seal recess.

6. The relay connector of claim 1, wherein:
the holder held portion of at least one of the plurality of terminals includes a positioning protrusion, and
the holder includes a positioning recess, the positioning protrusion being fit into the positioning recess.

7. The relay connector of claim 1, wherein a circumferential groove is formed in an outer periphery of the holder.

8. The relay connector of claim 1, wherein the press-fit portion is a part formed to be partially thick near the holder held portion, out of the inserting portion.

9. The relay connector of claim 8, wherein the press-fit portion is formed at a position to be press-fit into the insertion hole with the holder partially inserted in the holder recess.
